(19) United States
(12) Patent Application Publication
(10) Pub. No.: US 2025/0367702 A1
(43) Pub. Date: Dec. 4, 2025

(54) DUAL SLOT DIE COATER AND METHOD OF MANUFACTURING ELECTRODES USING SAME

(71) Applicant: SK On Co., Ltd., Seoul (KR)

(72) Inventors: Ju Hyun KIM, Daejeon (KR); Dae Hee KIM, Daejeon (KR); Ji Yeon PARK, Daejeon (KR)

(21) Appl. No.: 19/217,102

(22) Filed: May 23, 2025

(30) Foreign Application Priority Data
Jun. 4, 2024 (KR) 10-2024-0073308

(51) Int. Cl. B05C 11/10; B05C 5/02; B05C 9/06; H01M 4/04

(52) U.S. Cl. CPC B05C 11/1042; B05C 5/0254; B05C 9/06; B05C 11/1013; H01M 4/0402

(57) ABSTRACT

Proposed is a dual slot die coater, which includes a first die block provided with a first manifold for accommodating the first coating material, a second die block provided on one side of the first die block, a third die block interposed between the first die block and the second die block, a second manifold provided in either the second die block or the third die block and accommodating a second coating material, and a temperature controller provided in the first die block and capable of controlling temperature.

### CROSS REFERENCE TO RELATED APPLICATION

The present application claims priority to Korean Patent Application No. 10-2024-0073308, filed Jun. 4, 2024, the entire contents of which is incorporated herein for all purposes by this reference.

### BACKGROUND OF THE DISCLOSURE

### 1. Field of the Disclosure

The present disclosure relates to a dual slot die coater and a method of manufacturing an electrode using the same.

### 2. Description of the Related Art

As technology development and demand for mobile devices increase, demand for secondary batteries has also rapidly increased.

Among secondary batteries, lithium secondary batteries have high energy density and high operating voltage and show excellency in preservation and lifespan. Due to that, lithium secondary batteries are widely used as an energy source for various mobile devices as well as various electronic products.

As the application field for secondary batteries expands, demand for higher-capacity batteries has rapidly increased.

To increase the capacity of secondary batteries, research on techniques to increase a loading amount of an electrode mixture layer has been conducted as a solution.

Electrodes for secondary batteries are manufactured by coating a current collector with an electrode slurry and then bringing the coated current collector through a drying and rolling process. However, to increase the loading amount of an electrode mixture layer, a large amount of electrode slurry is required to be applied on the current collector during coating.

Furthermore, to increase the coating amount of electrode slurry, a higher level of coating uniformity is required.

In addition, to efficiently control a binder distribution within a negative electrode in high-capacity secondary batteries to reduce binder content, improve detachment phenomenon of an electrode mixture layer, and achieve rapid charging performance, research and development have been needed.

### RELATED ART DOCUMENTS

### Patent Documents

(Patent Document 1) KR 10-2430325 B1

### SUMMARY OF THE DISCLOSURE

One aspect of the present disclosure provides a dual slot die coater that enables to improve rapid charging performance and a method of manufacturing an electrode using the dual slot die coater.

According to the present disclosure, the dual slot die coater may include: a first die block provided with a first manifold for accommodating a first coating material; a second die block provided on one side of the first die block; a third die block interposed between the first die block and the second die block; a second manifold provided in either the second die block or the third die block and accommodating a second coating material; and a temperature controller provided in the first die block and capable of controlling temperature.

According to one embodiment, the temperature controller may be adjacent to the first manifold.

According to another embodiment, the temperature controller may include a flow path for a coolant and a heating wire.

According to a further embodiment, the temperature controller may include a temperature control device connected to the flow path and the heating wire.

According to a yet further embodiment, the temperature controller may include a plurality of the flow paths and/or a plurality of the heating wires.

According to a still yet further embodiment, the flow path and the heating wire may be adjacent to the first manifold.

According to a still yet further embodiment, the dual slot die coater of the present disclosure may include a coating material supply line for supplying the first coating material to the first manifold, and a pressure sensor provided in the coating material supply line and measuring a supply pressure of the first coating material inside the coating material supply line.

According to a still yet further embodiment, the dual slot die coater of the present disclosure may include a controller that is electrically connected to the pressure sensor and the temperature controller, respectively, and receives an electrical signal from the pressure sensor to operate the temperature controller.

According to a still yet further embodiment, the third die block may include an insulating material.

According to the present disclosure, a method of manufacturing an electrode using a dual slot die coater may include: a step of setting a supply pressure for a coating material to set a supply pressure of a first coating material inside a coating material supply line, which is for supplying the first coating material to a first manifold of a first die block; a step of measuring pressure to measure an internal supply pressure of the coating material supply line; a step of lowering temperature to lower temperature of the first coating material accommodated within the first manifold when a supply pressure of the first coating material inside the coating material supply line, as measured in the step of measuring pressure, is lower than the supply pressure set in the step of setting a supply pressure for a coating material; and a step of raising temperature to raise temperature of the first coating material accommodated within the first manifold when a supply pressure of the first coating material inside the coating material supply line, as measured in the step of measuring pressure, is higher than the supply pressure set in the step of setting a supply pressure for a coating material.

According to one embodiment, the step of lowering temperature may involve lowering temperature of the first coating material accommodated within the first manifold using a coolant.

According to another embodiment, the step of raising temperature may involve raising temperature of the first coating material accommodated within the first manifold using a heating wire.

According to a further embodiment, the method may include maintaining a supply pressure of the first coating material inside the first manifold at the supply pressure set in the step of setting a supply pressure for a coating material through the steps of lowering temperature and raising temperature.

The features and advantages of the present disclosure will become more apparent from the following detailed description based on the accompanying drawings.

Prior to this, terms or words used in this specification and claims should not be construed in their usual, dictionary meaning. Based on the principle that the inventor(s) can appropriately define the concept of the term to explain his or her invention in the best way, the terms or words are required to be interpreted with a meaning and concept consistent with the technical idea of the present disclosure.

One embodiment of the present disclosure can improve rapid charging performance and yield.

Another embodiment of the present disclosure can show an effect of stabilizing a profile of an electrode active material slurry.

### BRIEF DESCRIPTION OF THE DRAWINGS

FIG. 1 shows a conceptual diagram schematically showing a dual slot die coater according to a first embodiment;

FIG. 2 shows a conceptual diagram schematically showing an arrangement of a flow path for a coolant and a heating wire at one end of the first die block of the dual slot die coater according to the first embodiment;

FIG. 3 shows a flowchart showing a method for manufacturing an electrode using the dual slot die coater according to the first embodiment;

FIG. 4 shows a graph showing application characteristics of a coating material applied to an electrode when the first coating material accommodated inside the first manifold is at a preset temperature;

FIG. 5 shows a graph showing application characteristics of the coating material applied to the electrode when the first coating material accommodated inside the first manifold is at a temperature higher than the preset temperature;

FIG. 6 shows a graph showing application characteristics of the coating material applied to the electrode when the first coating material accommodated inside the first manifold is at a temperature lower than the preset temperature; and

FIG. 7 shows a conceptual diagram schematically showing a dual slot die coater according to a second embodiment.

### DESCRIPTION OF THE PREFERRED EMBODIMENTS

Hereinafter, the present disclosure will be described in detail (with reference to the attached drawings). However, this is merely illustrative and the present disclosure is not limited to the specific embodiments described by way of example.

In assigning reference numerals to components in the drawings, identical components are given the same reference numerals as much as possible even when they are shown in different drawings, and similar components are assigned similar reference numerals.

Terms used to describe one embodiment of the present disclosure are not intended to limit the present disclosure. It should be noted that singular expressions include plural expressions unless the context clearly indicates otherwise.

Drawings may be schematic or exaggerated for description of embodiments. In this document, expressions such as “have”, “may have”, “includes”, or “may include” refer to the presence of the corresponding feature (e.g., a component such as a numerical value, function, operation, or part) and do not exclude the presence of additional features.

Terms such as “one”, “other”, “another”, “first”, and “second” are used to distinguish one component from another component, and the components are not limited by these terms.

The embodiments described in this document and the accompanying drawings are not intended to limit the present disclosure to specific embodiments. This present disclosure is to be understood as including various modifications, equivalents, and/or alternatives of the embodiments.

Hereinafter, one embodiment of the present disclosure will be described in detail with reference to the attached drawings.

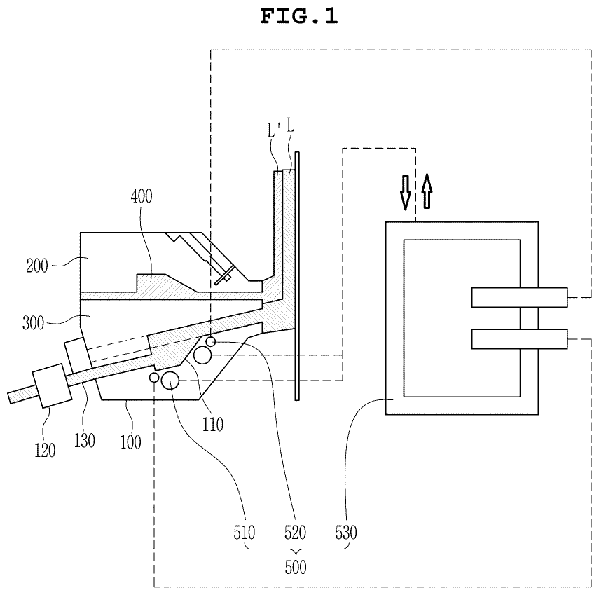

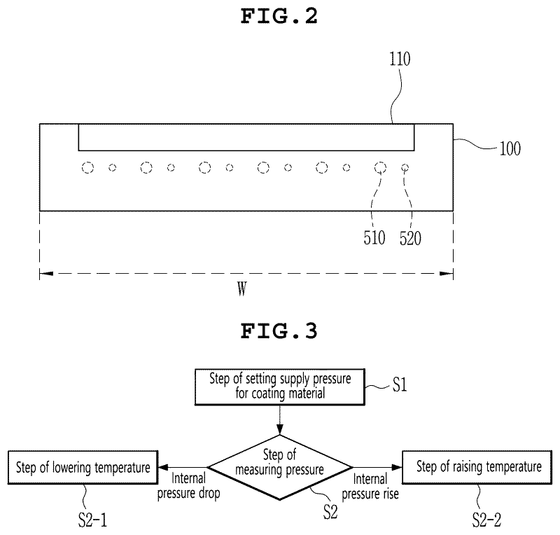

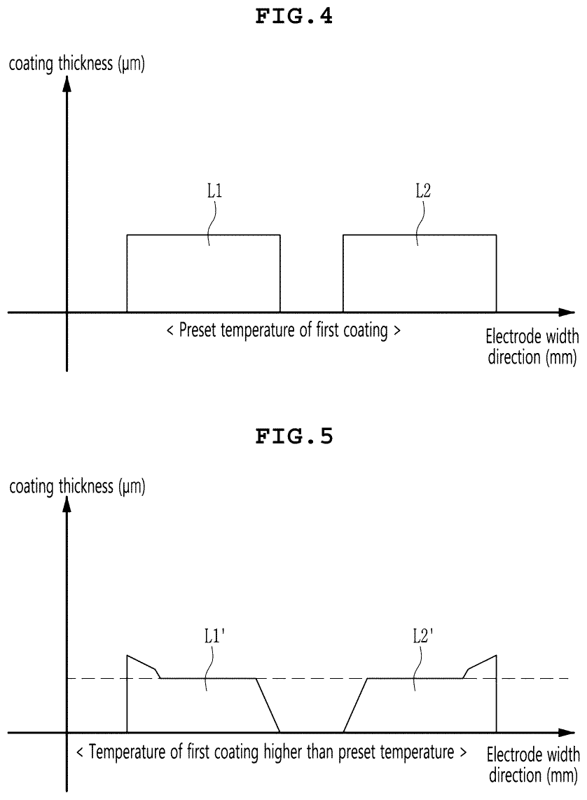

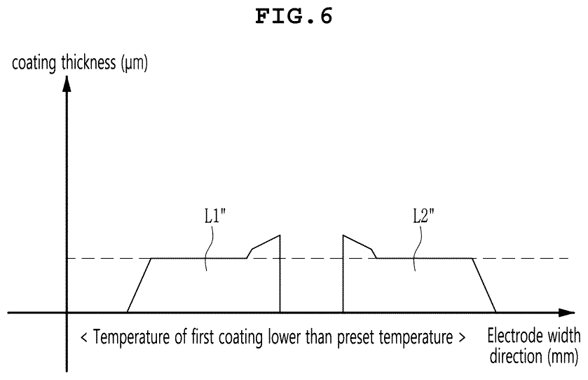

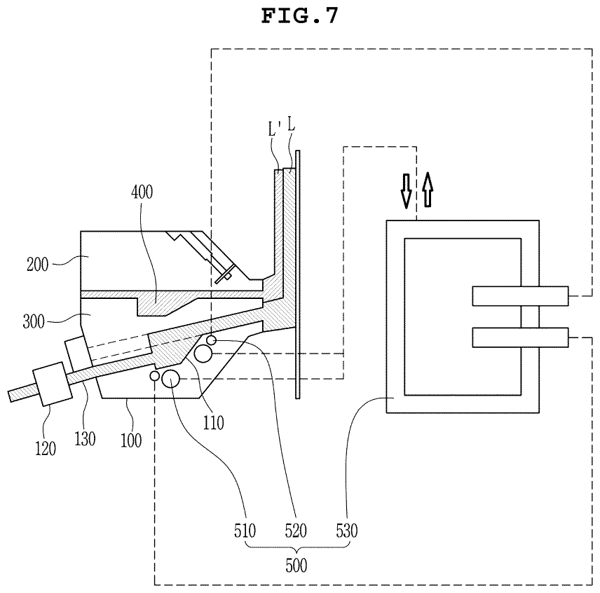

FIG. 1 shows a conceptual diagram schematically showing a dual slot die coater according to a first embodiment. FIG. 2 shows a conceptual diagram schematically showing an arrangement of a flow path for a coolant and a heating wire at one end of the first die block of the dual slot die coater according to the first embodiment. FIG. 3 shows a flowchart showing a method for manufacturing an electrode using the dual slot die coater according to the first embodiment. FIG. 4 shows a graph showing application characteristics of a coating material applied to an electrode when the first coating material accommodated inside the first manifold is at a preset temperature. FIG. 5 shows a graph showing application characteristics of the coating material applied to the electrode when the first coating material accommodated inside the first manifold is at a temperature higher than the preset temperature. FIG. 6 shows a graph showing application characteristics of the coating material applied to the electrode when the first coating material accommodated inside the first manifold is at a temperature lower than the preset temperature. FIG. 7 shows a conceptual diagram schematically showing a dual slot die coater according to a second embodiment.

As shown in FIGS. 1 and 2, the dual slot die coater according to a first embodiment of the present disclosure may include a first die block 100, a second die block 200, a third die block 300, a second manifold 400, and a temperature controller 500.

The first die block 100 may be provided with a first manifold 110. The first manifold 110 may accommodate a first coating material L therein.

The first die block 100 may be provided at the lower part of the dual slot die coater according to the first embodiment of the present disclosure, as shown in FIG. 1.

The first die block 100 may include a coating material supply line 130 and a pressure sensor 120.

The coating material supply line 130 extending from the outside to the inside of the first die block 100 may be connected to the first manifold 110 to communicate.

The coating material supply line 130 may supply the first coating material L to the inside of the first manifold 110.

The pressure sensor 120 may measure a supply pressure of the first coating material L flowing inside the coating material supply line 130.

The pressure sensor 120 may be a pressure sensor provided in the coating material supply line 130.

The pressure sensor is a type of manometer that measures pressure. The pressure sensor may be any one of a pressure gauge, pressure sensor, pressure detector, or pressure transducer that mainly converts and outputs measurement results into electrical signals, but is not limited thereto.

The pressure sensor 120 may be electrically connected to a controller (not shown).

The controller may operate a temperature controller 500 on the basis of an electrical signal received from the pressure sensor 120.

The controller may be electrically connected to the pressure sensor 120 and the temperature controller 500, respectively.

The controller may be provided inside the first die block 100 or may be provided outside the first die block 100.

The controller may set a reference supply pressure of the first coating material L flowing inside the coating material supply line 130, and the controller may determine an increase and decrease in pressure of the first coating material L flowing inside the coating material supply line 130 on the basis of the reference supply pressure.
the temperature controller 500 provided in the first die block 100 and capable of controlling temperature.
the temperature controller 500 is adjacent to the first manifold 110.

The temperature controller 500 may control temperature of the first coating material L accommodated within the first manifold 110.

The temperature controller 500 may include a flow path 510 for a coolant and a heating wire 520 and may include a temperature control device 530 connected to the flow path 510 and the heating wire 520.
the temperature controller 500 comprises a plurality of the flow paths 510 and/or a plurality of the heating wires 520.

When the supply pressure of the first coating material L flowing inside the coating material supply line 130 decreases, an internal temperature of the first manifold 110 may be lowered to increase the supply pressure of the first coating material L to the reference supply pressure.

That is, the pressure sensor 120 may transmit an electrical signal, as obtained by measuring the supply pressure of the first coating material L flowing inside the coating material supply line 130, to the controller.

When the controller determines that the supply pressure of the first coating material L flowing inside the coating material supply line 130 is lower than the reference supply pressure, the controller may manipulate the temperature control device 530 to allow the coolant to flow into the flow path 510.

Then, the flow path 510 may function to lower the internal temperature of the first manifold 110 with the coolant flowing along the inside.

In addition, as the internal temperature of the first manifold 110 decreases, and the viscosity of the first coating material L inside the first manifold 110 increases, the supply pressure of the first coating material L may be increased to the reference supply pressure.

The flow path 510 may be adjacent to the first manifold 110 inside the first die block 100.

In addition, a plurality of flow paths 510 may be arranged along the width direction of the first manifold 110 (reference symbol W in FIG. 2).

Therefore, a plurality of flow paths 510 may evenly transfer the temperature of the coolant to the entire area of the first manifold 110.

When the supply pressure of the first coating material L inside the coating material supply line 130 increases, the heating wire 520 may increase the internal temperature of the first manifold 110 to lower the supply pressure of the first coating material L to the reference supply pressure.

That is, the pressure sensor 120 may transmit an electrical signal, as obtained by measuring the supply pressure of the first coating material L flowing inside the coating material supply line 130, to the controller.

When the controller determines that the supply pressure of the first coating material L flowing inside the coating material supply line 130 is higher than the reference supply pressure, the controller may supply electricity to the heating wire 520 by manipulating the temperature control device 530.

Then, the heating wire 520 radiates heat energy through the supplied electricity, increases the internal temperature of the first manifold 110, and lowers the viscosity of the first coating material L inside the first manifold 110. Accordingly, the supply pressure of the first coating material L may be lowered to the reference supply pressure.

The heating wire 520 may be adjacent to the first manifold 110 inside the first die block 100. In addition, a plurality of heating wires 520 may be arranged along the width direction of the first manifold 110 (reference symbol W in FIG. 2).

Therefore, a plurality of heating wires 520 may evenly transfer heat energy to the entire area of the first manifold 110.

The temperature control device 530 may supply a coolant to the flow path 510 or supply electricity to the heating wire 520 by manipulation of the controller.

The temperature control device 530 may be provided outside the first die block 100. The temperature control device 530 may be electrically connected to the controller.

The temperature control device 530 may include a thermostat, but is not limited thereto.

The second die block 200 may be provided on one side of the first die block 100.

A third die block 300 may be interposed between the first die block 100 and the second die block 200.

The third die block 300 may be made of an insulating material. That is, the third die block 300 made of an insulating material may block the temperature of the first die block 100 from being transferred to the second die block 200, as interposed between the first die block 100 and the second die block 200.

A second manifold 400 may be provided in either the second die block 200 or the third die block 300.

Referring to FIG. 1, according to the first embodiment of the present disclosure, the second die block 200 may be provided with a second manifold 400 therein.

Referring to FIG. 7, according to the second embodiment of the present disclosure, the third block 300 may be provided with a second manifold 400 therein.

The second manifold 400 may accommodate a second coating material L′ therein.

The first manifold 110 and the second manifold 400 may discharge the first coating material L and the second coating material L′, respectively, through their corresponding outlets opening on one side.

The present disclosure may control slurry application by controlling only the temperature of the first coating material L accommodated in the first manifold 110.

The first coating material L and the second coating material L′ may include an electrode slurry and a primer.

For example, the first coating material L may be an electrode slurry, and the second coating material L′ may be a primer.

As another example, the first coating material L and the second coating material L′ may be an electrode slurry.

Herein, the primer may improve a binding force of the electrode slurry applied on the electrode for coating.

### [Positive Electrode]

A positive electrode may include a positive electrode current collector and a positive electrode mixture layer disposed on at least one side of the positive electrode current collector.

### (Positive Electrode Current Collector)

The positive electrode current collector may include stainless steel, nickel, aluminum, titanium, or alloys thereof.

The positive electrode current collector may include aluminum or stainless steel surface-treated with carbon, nickel, titanium, or silver.

The length of the positive electrode current collector is not limited thereto, but may be, for example, 10 to 50 μm.

### (Positive Electrode Material)

The positive electrode mixture layer may include a positive electrode active material. The positive electrode active material may include a compound capable of reversibly intercalating and de-intercalating lithium ions.

According to exemplary embodiments, the positive electrode active material may include a lithium-nickel metal oxide. The lithium-nickel metal oxide may further include at least one selected from the group consisting of cobalt (Co), manganese (Mn), and aluminum (Al).

In some embodiments, the positive electrode active material or the lithium-nickel metal oxide may have a layered structure or a crystal structure represented by Formula 1 below.

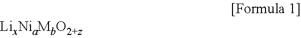

In Formula 1, x, a, b, and z may satisfy the ranges of 0.9≤x≤1.2, 0.6≤a≤0.99, 0.01≤b≤0.4, and −0.5≤z≤0.1, respectively. As mentioned above, M may include Co, Mn, and/or Al.

The chemical structure represented by Formula 1 represents a bonding relationship formed within the layered structure or crystal structure of the positive electrode active material, and in the bonding, other additional elements are not excluded.

For example, M includes Co and/or Mn, and Co and/or Mn may be provided along with Ni as the main active elements of the positive electrode active material. Formula 1 represents a bonding relationship of the main active elements, and it should be understood that the bonding relationship encompasses introduction and substitution of the additional elements.

In one embodiment, in addition to the main active elements, auxiliary elements to improve chemical stability of the positive electrode active material or the layered structure/crystal structure may be further included.

The auxiliary elements may be integrated together in the layered structure/crystal structure to form a bond, and in this case, it should be understood that the auxiliary elements satisfy the ranges for forming the chemical structure represented by Formula 1.

The auxiliary elements may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr.

For example, the auxiliary elements, such as Al, may act together with Co or Mn as auxiliary active elements that contribute to capacity/output activity of the positive electrode active material.

For example, the positive electrode active material or the lithium-nickel metal oxide may have a layered structure or a crystal structure represented by Formula 1-1 below.

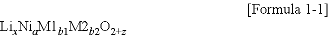

In Formula 1-1, M1 may include Co, Mn, and/or Al. M2 may include the above-described auxiliary elements. In Formula 1-1, x, a, b1+b2, and z may satisfy the ranges of 0.9≤x≤1.2, 0.6≤a≤0.99, 0.01<b1+b2≤0.4, and −0.5≤z≤0.1, respectively.

The positive electrode active material may further include a coating element or a doping element.

For example, elements substantially the same as or similar to the above-described auxiliary elements may be used as the coating element or doping element.

For example, any of the above-mentioned elements, alone or in combination with two or more of them, may be used as the coating element or doping element.

The coating element or doping element is present on the surface of the lithium-nickel metal oxide particle, or penetrates through the surface of the lithium-nickel metal composite oxide particle. Therefore, the coating element or doping element may be contained in the bonding structure represented by Formula 1 or Formula 1-1.

The positive electrode active material may include nickel-cobalt-manganese (NCM)-based lithium oxide. In this case, the NCM-based lithium oxide with increased nickel content may be used.

Ni may be provided as a transition metal related to the output and capacity of lithium secondary batteries.

Therefore, by adopting a high-Ni composition to the positive electrode active material as described above, a high-capacity positive electrode and a high-capacity lithium secondary battery may be provided.

However, as the Ni content increases, the long-term storage stability and lifetime stability of the positive electrode or secondary battery may relatively deteriorate, and side reactions with the electrolyte may also increase.

However, according to exemplary embodiments, Co containment may allow for electrical conductivity, while Mn containment may allow for improvement in life stability and capacity maintenance properties.

A Ni content (e.g., a mole fraction of nickel in the total number of moles of nickel, cobalt, and manganese) in the NCM-based lithium oxide may be in a range of 0.6 or more, 0.7 or more, or 0.8 or more.

In some embodiments, the Ni content may be in a range of 0.8 to 0.95, 0.82 to 0.95, 0.83 to 0.95, 0.84 to 0.95, 0.85 to 0.95, or 0.88 to 0.95.

In some embodiments, the positive electrode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the positive electrode active material may include, for example, a Mn-rich-based active material, a Li-rich layered oxide (LLO)/over lithiated oxide (OLO)-based active material, or a Co-less-based active material having a chemical structure or a crystal structure represented by Formula 2.

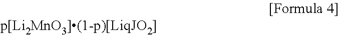

In Formula 2, p and q satisfy the ranges of 0<p<1 and 0.9≤q≤1.2, respectively. J may include at least one element selected from the group consisting of Mn, Ni, Co, Fe, Cr, V, Cu, Zn, Ti, Al, Mg, and B.

### (Manufacturing Method of Positive Electrode)

After applying the positive electrode slurry on a positive electrode current collector for coating, a positive electrode mixture layer may be prepared by drying and rolling.

A process for coating may be performed by methods such as gravure coating, slot die coating, multi-layer simultaneous die coating, imprinting, doctor blade coating, dip coating, bar coating, and casting, but is not limited thereto.

The positive electrode mixture layer may further include a binder and optionally may further include a conductive material and a thickener.

### (Positive Electrode Solvent)

Non-limiting examples of solvents used to prepare a positive electrode mixture may include N-methyl-2-pyrrolidone (NMP), dimethylformamide, dimethylacetamide, N,N-dimethylaminopropylamine, ethylene oxide, and tetrahydrofuran.

### (Positive Electrode Binder)

The binder may contain polyvinylidenefluoride (PVDF), vinylidene fluoride-hexafluoropropylene copolymer (Poly(vinylidene fluoride-co-hexafluoropropylene), polyacrylonitrile, polymethylmethacrylate, acrylonitrile butadiene Rubber (NBR), polybutadiene rubber (BR), and styrene-butadiene rubber (SBR). In one embodiment, a PVDF-based binder may be used as the positive electrode binder.

### (Positive Electrode Conductive Material)

The conductive material may be added to improve conductivity of the positive electrode mixture layer and/or mobility of lithium ions or electrons.

For example, the conductive material may include, but is not limited to, carbon-based conductive materials including graphite, carbon black, acetylene black, Ketjen black, graphene, carbon nanotubes, vapor-grown carbon fiber (VGCF), and carbon fiber, and/or metal-based conductive materials including perovskite materials such as tin, tin oxide, titanium oxide, LaSrCoO₃, and LaSrMnO₃.

### (Positive Electrode Thickener/Dispersant)

If necessary, the positive electrode mixture may further include a thickener and/or a dispersant.

In one embodiment, the positive electrode mixture may include a thickener such as carboxymethyl cellulose (CMC).

### [Negative Electrode]

A negative electrode may include a negative electrode current collector and a negative electrode mixture layer disposed on at least one side of the negative electrode current collector.

### (Negative Electrode Current Collector)

Non-limiting examples of the negative electrode current collector may include copper foil, nickel foil, stainless steel foil, titanium foil, nickel foam, copper foam, and a polymer substrate coated with a conductive metal.

The length of the negative electrode current collector is not limited thereto, but may be, for example, 10 to 50 μm.

### (Negative Electrode Material)

The negative electrode mixture layer may include a negative electrode active material. A material capable of adsorbing and desorbing lithium ions may be used as the negative electrode active material.

For example, the negative electrode active material may include carbon-based materials such as crystalline carbon, amorphous carbon, carbon composite, and carbon fiber; lithium metals; lithium alloys; silicon (Si)-containing materials or tin (Sn)-containing materials may be used.

The amorphous carbon may include hard carbon, soft carbon, coke, mesocarbon microbeads (MCMB), and mesophase pitch-based carbon fiber (MPCF).

The crystalline carbon may include graphite-based carbon such as natural graphite, artificial graphite, graphitized coke, graphitized MCMB, and graphitized MPCF.

The lithium metals may include pure lithium metals or lithium metals with a protective layer formed thereon to inhibit dendrite growth.

In one embodiment, a lithium metal-containing layer deposited or applied on a negative electrode current collector for coating may be used as a negative electrode active material layer. In one embodiment, a lithium thin film layer may be used as the negative electrode active material layer.

Elements contained in the lithium alloys may include aluminum, zinc, bismuth, cadmium, antimony, silicon, lead, tin, gallium, or indium.

The silicon-containing materials may provide increased capacitance properties.

The silicon-containing material may contain Si, SiOₓ (0<x<2), metal-doped SiOₓ (0<x<2), and silicon-carbon composite.

The metals may include lithium and/or magnesium, and the metal-doped SiOₓ (0<x<2) may include metal silicate.

### (Manufacturing Method for Negative Electrode)

After applying/depositing the negative electrode slurry on the negative electrode current collector for coating, a negative electrode mixture layer may be prepared by drying and rolling.

A process for coating may be performed by methods such as gravure coating, slot die coating, multi-layer simultaneous die coating, imprinting, doctor blade coating, dip coating, bar coating, and casting, but is not limited thereto.

The negative electrode mixture layer may further include a binder and optionally may further include a conductive material and a thickener.

In some embodiments, the negative electrode may include a negative electrode active material layer in the form of lithium metal formed through a deposition/coating process.

### (Negative Electrode Solvent)

Non-limiting examples of a solvent for a negative electrode mixture may include water, pure water, deionized water, distilled water, ethanol, isopropanol, methanol, acetone, n-propanol, and t-butanol.

### (Negative Electrode Binder/Conductive Material/Thickener)

The above-described materials that may be used in manufacturing a positive electrode may be used as a binder, conductive material, and thickener.

In some embodiments, a styrene-butadiene rubber (SBR)-based binder, carboxymethyl cellulose (CMC), polyacrylic acid-based binder, and poly(3,4-ethylenedioxythiophene) (PEDOT)-based binder may be used as the negative electrode binder.

Referring to FIG. 3, the method for manufacturing an electrode using the dual slot die coater of the present disclosure may include a step of setting a supply pressure for a coating material S1, a step of measuring pressure S2, a step of lowering temperature S2-1, and a step of raising temperature S2-2.

Referring to FIGS. 1 to 3, The step of setting a supply pressure for a coating material S1 may involve setting a supply pressure of the first coating material L flowing inside the coating material supply line 130, which supplies the first coating material L to the first manifold 110 of the first die block 100.

In the step of setting a supply pressure for a coating material S1, a set supply pressure of the first coating material L flowing inside the coating material supply line 130 may be set as a reference supply pressure.

In the step of measuring pressure S2, an internal supply pressure of the coating material supply line 130 may be measured using the pressure sensor 120.

In the step of lowering temperature S2-1, an electrical signal for the supply pressure of the first coating material L inside the coating material supply line 130 measured in the step of measuring pressure S2 may be transmitted from the pressure sensor 120 to the controller.

When determining an electrical signal transmitted from the pressure sensor 120, the controller may determine that a supply pressure of the first coating material L inside the coating material supply line 130 measured in the step of measuring pressure S2 is lower than the supply pressure set in the step of setting a supply pressure for a coating material.

Then, the controller may manipulate the temperature control device 530 to flow a coolant into the flow path 510.

As a result, the temperature of the first coating material L accommodated in the first manifold 110 located near the flow path 510 is lowered by the coolant flowing inside the flow path 510. This may increase the internal pressure of the first coating material L to the reference pressure. In the step of raising temperature S2-2, an electrical signal for the supply pressure of the first coating material L inside the coating material supply line 130 measured in the step of measuring pressure S2 may be transmitted from the pressure sensor 120 to the controller.

When determining an electrical signal transmitted from the pressure sensor 120, the controller may determine that a supply pressure of the first coating material L inside the coating material supply line 130 measured in the step of measuring pressure S2 is higher than the supply pressure set in the step of setting a supply pressure for a coating material.

Then, the controller may supply electricity to the heating wire 520 by manipulating the temperature control device 530.

As a result, the heating wire 520 radiates heat energy through supplied electricity, and increases the temperature of the first coating material L accommodated inside the first manifold 110 located near the heating wire 520. This may lower the internal pressure of the first coating material L to the reference pressure.

As described above, the method for manufacturing an electrode using the dual slot die coater of the present disclosure may maintain an internal supply pressure of the first manifold 110 at the supply pressure set in the step of setting a supply pressure for a coating material S1 through the steps of lowering temperature S2-1 and raising temperature S2-2.

Accordingly, the method for manufacturing an electrode using the dual slot die coater of the present disclosure may stabilize the application properties (profile) of the first coating material L inside the first manifold 110.

That is, in the method for manufacturing an electrode using the dual slot die coater of the present disclosure, a pressure, as measured when the temperature of the first coating material L accommodated within the first manifold 110 is a preset temperature, may be set as the reference supply pressure.

In addition, referring to FIG. 4, when the temperature of the first coating material L accommodated inside the first manifold 110 is the preset temperature, it can be seen that, among the coating materials applied to the electrode, a first coating layer L1 and a second coating layer L2, which are formed through coating at different positions in the width direction of the electrode, may show application characteristics of maintaining both a uniform coating thickness and width.

The electrode interposed between the first coating layer L1 and the second coating layer L2 may become an uncoated region.

The uncoated region may have a coating thickness of 0 μm. The uncoated region may refer to a part of the electrode where the thickness of the coating is 0 μm.

When a temperature of the first coating material L accommodated within the first manifold 110 is higher than the preset temperature, viscosity of the first coating material L may be lowered.

In this case, the first coating material L may be concentrated on both sides of the first die block 100 due to inertia.

That is, referring to FIG. 5, a first coating layer L1′ and a second coating layer L2′ formed through coating at different positions in the width direction of the electrode may have a problem in that their coating thickness at the opposite (outer) end becomes thicker or their thickness at the inner end becomes thinner.

When a temperature of the first coating material L accommodated within the first manifold 110 is lower than the preset temperature, viscosity of the first coating material L may be increased. In this case, the first coating L may be concentrated toward the center of the first die block 100 due to inertia.

That is, referring to FIG. 6, among the coating materials applied to the electrode, a first coating layer L1″ and a second coating layer L2″ formed through coating at different positions in the width direction of the electrode may have a problem in that their coating thickness at the (inner) end of the facing side to each other may become thicker.

Alternatively, the first coating layer L1″ and a second coating layer L2″ may have a problem in that the outer ends of theirs, which are opposite to each other, become thinner.

In this way, when a temperature of the first coating material L accommodated inside the first manifold 110 is maintained in a constant way at a preset temperature, the application characteristics (profile) of the first coating material L may be stabilized.

In addition, the method for manufacturing an electrode using the dual slot die coater of the present disclosure may enable to reduce a content of the binder by efficiently controlling binder distribution within the negative electrode.

Through this, a method of controlling an electrode using the dual slot die coater of the present disclosure may enable to manufacture a negative electrode for secondary batteries with improved rapid charging performance while preventing the electrode mixture layer from being detached.

The method for manufacturing an electrode using the dual slot die coater of the present disclosure may enhance stability of a dual coating process by maintaining an internal supply pressure of the first manifold 110 at a supply pressure set in the step of setting a supply pressure for a coating material S1.

The method for manufacturing an electrode using the dual slot die coater of the present disclosure may significantly increase an yield of the negative electrode manufactured by a dual slot die coater by maintaining the internal supply pressure of the first manifold 110 at the supply pressure set in the step of setting a supply pressure for a coating material S1.

TABLE 1

| | | | Experi- | Compar- | Compar- |
|---|---|---|---|---|---|
| | | | mental | ative | ative |
| | | | Example | Example 1 | Example 2 |
| Coater | Negative | Coater | 47.7% | 56.7% | 64.8% |
| Operation Rate | Electrode | | | | |
| Yield | | | 88.02% | 86.94% | 84.69% |

Table 1 shows experimental data from manufacturing facilities that manufacture electrodes using dual slot die coaters. This table shows a comparison of negative electrode coater operation rates and negative electrode yields obtained by the dual slot die coater of the present disclosure and dual slot die coaters manufactured by conventional methods.

In Experimental Example, a negative electrode was manufactured while maintaining an internal supply pressure in the lower part of the die block at the supply pressure set in the step of setting a supply pressure for a coating material S1.

In Experimental Example, the negative electrode coater operation rate and the negative electrode yield were calculated in an electrode manufacturing facility that enhanced the stability of the dual coating process according to an embodiment of the method for manufacturing an electrode using the dual slot die coater of the present disclosure.

In Experimental Example, it was found that the negative electrode coater operation rate of the electrode was 47.7%, and the negative electrode yield of the electrode in the coater was 88.02%.

In Comparative Example 1, a negative electrode was manufactured in a manufacturing facility that manufactured electrodes using a conventional dual slot die coater, which could not adjust loading of the lower die block.

In Comparative Example 1, the negative electrode coater operation rate and negative electrode yield from the electrode manufacturing facility using the conventional dual slot die coater were calculated, respectively.

In Comparative Example 1, it was found that the negative electrode coater operation rate of the electrode was 56.7%, and the negative electrode yield of the electrode was 86.94%.

In Comparative Example 2, a negative electrode was manufactured in a manufacturing facility that manufactured electrodes using a conventional wet-on-wet method, by which two coaters were dually installed.

In Comparative Example 2, the negative electrode coater operation rate and negative electrode yield from the electrode manufacturing facility using the conventional wet-on-wet method were calculated, respectively.

In Comparative Example 2, it was found that the negative electrode coater operation rate of the electrode was 64.8%, and the negative electrode yield of the electrode was 84.69%.

Referring to Table 1, it can be seen that the method for manufacturing an electrode using the dual slot die coater of the present disclosure enhances the stability of the dual coating process and significantly improves the negative electrode coater operation rate and the negative electrode yield of an electrode compared to the conventional methods.

In other words, the dual slot die coater of the present disclosure has a significant effect on improving a negative electrode coater operation rate and negative electrode yield of the electrode compared to the conventional dual slot die coater of Comparative Example 1 and the conventional wet-on-wet method of Comparative Example 2.

The present disclosure has been described in detail through specific examples. The content described above are merely examples of applying the principles of the present disclosure, and other configurations may be further included without departing from the scope of the present disclosure.

What is claimed is:

1. A dual slot die coater, comprising:
a first die block provided with a first manifold for accommodating a first coating material,
a second die block provided on one side of the first die block,
a third die block interposed between the first die block and the second die block,
a second manifold provided in either the second die block or the third die block and accommodating a second coating material, and
a temperature controller provided in the first die block and capable of controlling temperature.

2. The dual slot die coater of claim 1, wherein the temperature controller is adjacent to the first manifold.

3. The dual slot die coater of claim 1, wherein the temperature controller comprises:
a flow path for a coolant and
a heating wire.

4. The dual slot die coater of claim 3, wherein the temperature controller comprises a temperature control device connected to the flow path and the heating wire.

5. The dual slot die coater of claim 3, wherein the temperature controller comprises a plurality of the flow paths and/or a plurality of the heating wires.

6. The dual slot die coater of claim 3, wherein the flow path and the heating wire are adjacent to the first manifold.

7. The dual slot die coater of claim 1, further comprising:
a coating material supply line for supplying the first coating material to the first manifold and
a pressure sensor provided in the coating material supply line and measuring a supply pressure of the first coating material inside the coating material supply line.

8. The dual slot die coater of claim 7, further comprising a controller which is electrically connected to the pressure sensor and the temperature controller, respectively, and receives an electrical signal from the pressure sensor to operate the temperature controller.

9. The dual slot die coater of claim 1, wherein the third die block comprises an insulating material.

10. A method of manufacturing an electrode using a dual slot die coater, the method comprising:
a step of setting a supply pressure for a coating material to set a supply pressure of a first coating material inside a coating material supply line, which is for supplying the first coating material to a first manifold of a first die block,
a step of measuring pressure to measure an internal supply pressure of the coating material supply line,
a step of lowering temperature to lower temperature of the first coating material accommodated within the first manifold when a supply pressure of the first coating material inside the coating material supply line, as measured in the step of measuring pressure, is lower than the supply pressure set in the step of setting a supply pressure for a coating material, and
a step of raising temperature to raise temperature of the first coating material accommodated within the first manifold when a supply pressure of the first coating material inside the coating material supply line, as measured in the step of measuring pressure, is higher than the supply pressure set in the step of setting a supply pressure for a coating material.

11. The method of claim 10, wherein the step of lowering temperature comprises lowering temperature of the first coating material accommodated within the first manifold using a coolant.

12. The method of claim 10, wherein the step of raising temperature comprises raising temperature of the first coating material accommodated within the first manifold using a heating wire.

13. The method of claim 10, comprising maintaining a supply pressure of the first coating material inside the first manifold at the supply pressure set in the step of setting a supply pressure for a coating material through the steps of lowering temperature and raising temperature.
